(19) United States
(12) Patent Application Publication
(10) Pub. No.: US 2004/0086411 A1
(43) Pub. Date: May 6, 2004

(54) Compressor-use helical blade and production method therefor, and compressor using this blade

(76) Inventors: Satoshi Oyama, Fuji-shi (JP); Tetsuo Fukuda, Fuji-shi (JP); Takahiro Nishikawa, Neyagawa-shi (JP); Noriyuki Akane, Neyagawa-shi (JP); Yoshiki Myojo, Neyagawa-shi (JP); Kiyotaka Miyagai, Neyagawa-shi (JP)

Correspondence Address: BIRCH STEWART KOLASCH & BIRCH, PO BOX 747, FALLS CHURCH, VA, 22040-0747, US

(21) Appl. No.: 10/471,024

(22) PCT Filed: Mar. 7, 2002
(86) PCT No.: PCT/JP02/02121

(30) Foreign Application Priority Data
Mar. 9, 2001 (JP) 2001-066717

(51) Int. Cl. F04C 15/00; B29C 45/00

(52) U.S. Cl. 418/220; 264/127; 264/328.18

(57) ABSTRACT

The present invention provides a PFA resin helical blade for use in a compressor, which is superior in dimensional precision and surface smoothness with a superior anti-fatigue property, and a manufacturing method thereof. In a manufacturing method of a compressor-use helical blade of the present invention, a PFA composite resin, which is formed by mixing an inorganic filler with a tetrafluoroethylene/perfluoroalkylvinyl ether copolymer (PFA resin) having a —CH₂OH terminal group, which has not been subjected to a stabilizing process, and has fluidity of not ness than 15 g/10 min, is used, and after the resin has been molded into a helical blade through an injection-molding process, the resulting matter is subjected to a heating process at a temperature from 280 to 300° C. for a period from not less than 10 hours to not more than 300 hours. The compressor-use helical blade, made of the PFA composite resin by using the above-mentioned method, is allowed to have an increased molecular weight of not more than 10 g/10 min represented as an MFR (melt flow rate) value.

### TECHNICAL FIELD

The present invention relates to a helical blade to be used for a compressor for use in a refrigerating cycle device, and more specifically concerns a PFA resin helical blade that is superior in anti-fatigue property in addition to dimensional precision and surface smoothness and a manufacturing method thereof.

### BACKGROUND ART

In general, a refrigerating cycle device is provided with a compressor for compressing a refrigerating gas.

With respect to the compressor for this purpose, in addition to reciprocating-type compressors and rotary-type compressors, helical compressors in which a spiral-shaped blade (hereinafter, referred to as helical blade) is adopted have been known.

In the helical compressor, a cylinder is installed in a sealing case with a roller placed in an eccentric manner, and this roller is designed to revolve within the cylinder.

A helical blade is fitted to a spiral-shaped groove formed on the outer circumferential face of the roller, with the blade being interposed between the roller and the cylinder.

A plurality of compression chambers are formed as compartments along the axial direction between the cylinder and the roller by the helical blade. A refrigerating gas is sucked into the compression chambers from one end of the roller, and while the compression chamber is shifted toward the other end of the roller following the revolution (eccentric rotation) of the roller, is gradually compressed continuously, so that a high-pressure refrigerating gas is discharged into the sealing case from the other end of the roller.

In addition to advantages that it requires fewer parts and its manufacturing and assembling processes of parts are easily carried out in comparison with the reciprocating-type compressor and the rotary-type compressor, the helical compressor features that the refrigerating gas is compressed continuously and smoothly with hardly any discharge pulsation.

However, the helical blade, placed in the helical compressor, is fitted to the spiral-shaped groove of the roller with uneven pitches, and allowed to protrude from and recess into the spiral groove following the revolution of the roller. Upon protruding and recessing from and into the spiral-shaped groove, the helical blade tends to pass through portions (spiral-shaped groove) having different spiral pitches due to a difference in relative movements in the roller and the helical blade, with the result that the helical blade is susceptible to fatigue upon each of its protrusion and recession.

When the spiral pitches of the helical blade and the roller spiral-shaped groove are extremely different from each other, a great deforming force is forcefully exerted on the helical blade that protrudes from and recesses into the spiral groove so that the helical blade is subjected to a great distortion with a mechanical loss being caused by the protrusion and recession of the roller from and into the spiral-shaped groove. Therefore, a helical blade having the same pitch as the spiral-shaped groove of the roller is used.

With respect to the material of the helical blade, by taking into consideration characteristics of the helical blade to be used in the helical compressor, a fluororesin material having material characteristics, such as flexibility, heat-resistance, weatherability (refrigerator oil, temperature, coolant) and low coefficient of friction, is used.

In particular, a tetrafluoroethylene/perfluoroalkylvinyl ether copolymer (hereinafter, referred to simply as PFA resin), which is superior in heat-resistance, weatherability and low coefficient of friction, and has a good heating melt processability in an injection-molding process or the like, is preferably used.

With respect to a manufacturing method of the helical blade having the same pitch as the spiral-shaped groove of the roller, an injection molding process is preferably used. The injection molding process is superior in its productivity. With respect to a metal mold used for the injection molding process, a spiral-shaped groove having the same uneven pitches as the spiral-shaped groove of the roller is formed thereon, and a molten molding resin material (fluororesin material) is press-inserted into the spiral-shaped groove of the metal mold so that this is cooled and solidified inside the mold to form a helical blade having the same uneven pitches as those of the roller groove.

With respect to the metal mold, for example, those disclosed in Japanese Patent Application Laid-Open No. 4-72489 may be used. This patent gazette has proposed a structure of an injection gate of a metal mold, and with this structure of the metal mold, the helical blade is formed with the same uneven pitches as those of the spiral-shaped groove of the roller, and it is possible to ensure a smooth seal face without scratches caused by the injection gate.

The helical blade formed by an injection-molding process is advantageous in that the formation of a resin layer (skin layer) on the blade surface makes it possible to obtain a superior sliding property.

Patent Gazette No. 2,839,569 has disclosed that, upon forming a helical blade by using an injection molding process as described above, a perfluoroalkoxy resin material (PFA resin material) having a melt flow rate MFR (synonymous with melt flow index; hereinafter, referred to simply as MFR) of not less than 20 g/10 min is used so that it becomes possible to improve the dimensional precision of the helical blade by its high fluidity, and consequently to obtain a smooth seal face.

Here, MFR is defined in compliance with ASTM D3307, and used as a scale for indicating the fluidity of a thermoplastic resin material upon injection molding process, and represents the number of grams of the material that is extruded through an orifice having a fixed aperture for 10 minutes upon application of a predetermined load at a predetermined temperature.

It is preferable to use such a resin having a high melt fluidity because, in the case when the injection-molding process is carried out by using a resin having a low melt fluidity, upon injection of a molding resin material through the end portion of a spiral-shaped groove of a metal mold, the flow distance of the molten molding resin material is too long, which causes insufficient transmission of the molding pressure, consequently failing to provide high dimensional precision and smoothness of the blade surface in the resulting helical blade.

However, the value of MFR that serves as a scale for representing the fluidity of the resin is closely related to the molecular weight of the molding resin material, and the greater the value of MFR, the smaller the molecular weight, and in contrast, the smaller the value of MFR, the greater the molecular weight.

It has been found that the fatigue characteristic concerned with the reliability of the helical blade is also closely related to the molecular weight, with the result that the greater the molecular weight, more superior in the fatigue characteristic. In other words, the high fluidity of the molding resin material causes degradation in the fatigue characteristic and the subsequent degradation in the blade reliability.

Moreover, another problem is that, since the helical blade and the spiral-shaped groove of the roller are allowed to slide on each other, abrasion occurs when only the PFA resin is used. Therefore, in order to improve the abrasion resistance, a method in which a filler such as glass fibers is mixed therein has been proposed (hereinafter, referred to simply as PFA composite resin)

However, in order to lower MFR for the PFA composite resin, a material having a high value of MFR (small molecular weight) needs to be preliminarily used and added to a molding resin material (a base material). Another problem with the PFA composite resin is that the mixture of a filler therein causes great degradation in the fatigue characteristic.

In other words, upon application of the PFA composite resin material, a molding resin material having a smaller molecular weight is required, and since the filler further causes degradation in the fatigue characteristic, the reliability of the blade is further lowered.

In the PFA composite resin material, upon sliding, the filler serves as a frictional resistance, and the coefficient of dynamic friction increases. For this reason, the coefficient of dynamic friction between the blade and the roller as well as cylinder to slide therewith increases, resulting in a sliding loss and subsequent degradation in the compressor performance.

### DISCLOSURE OF INVENTION

The object of the present invention is to provide a PFA resin helical blade that is superior in dimensional precision and surface smoothness with superior sliding characteristic and anti-fatigue property, and a manufacturing method thereof, and also to provide a helical compressor having high reliability and compressor performances by using this helical blade.

The present invention relates to a manufacturing method of a compressor-use helical blade in which: a PFA composite resin is formed by mixing an inorganic filler with a tetrafluoroethylene/perfluoroalkylvinyl ether copolymer (PFA resin) having a —CH₂OH terminal group, which has not been subjected to a stabilizing process, and after the resin has been molded into a helical blade through an injection-molding process, the resulting matter is subjected to a heating process at a temperature from 280 to 300° C. for a period from not less than 10 hours to not more than 300 hours.

In particular, the present invention relates to a manufacturing method of the compressor-use helical blade, in which the fluidity of the PFA composite resin prior to the heating process is set to a value not less than 15 g/10 min as an MFR (melt flow rate) value.

The present invention relates to a PFA resin compressor-use helical blade which is obtained by the above-mentioned method and has a molecular weight that is increased to 10 g/10 min represented by the MFR value.

Furthermore, the present invention relates to a compressor which is provided with a cylinder, a roller that is placed in the cylinder in an eccentric manner and a helical blade that is placed in a spiral-shaped groove formed in either of the above-mentioned cylinder and the roller with its pitch being gradually reduced from one end thereof toward the other end, so as to freely stick out therefrom and retreat therein, and in this arrangement, the helical blade is formed by using the above-mentioned method.

The present invention features that a PFA resin having an optimal fluidity for injection molding is used to form a molded member that has superior dimensional precision and surface smoothness, and that the molded member is subjected to a heating process at a specific temperature so that the weight-average molecular weight of the PFA resin constituting the molded member is improved; thus, the molded member is allowed to have superior physical characteristics such as an anti-fatigue property.

More particularly, in the present invention, a PFA composite resin, which contains an inorganic filler as a composite material, and has a —CH₂OH terminal group, which has not been subjected to a stabilizing process in its terminal group with a fluidity of not less than 15 g/10 min represented as an MFR (Melt Flow Rate) value, is molded into a helical blade through an injection-molding process, and the resulting matter is then subjected to a heating process at a temperature from 280 to 300° C. for a period from not less than 10 hours to not more than 300 hours; thus, it becomes possible to provide a helical blade made of the PFA composite resin, which is superior in dimensional precision and surface smoothness with a superior anti-fatigue property and a sliding property, and also to provide a helical compressor that uses this helical blade.

With respect to similar techniques, there is a description on page 94 to 99 (1980) in “International wire & cable Symposium Proceedings”, which indicates that, when a PFA resin has been subjected to an aging process at 285° C. for 20,000 hours, the PFA resin is allowed to have an increased tensile strength, and that, when subjected to an aging process at a high temperature (at 230° C. and 280° C.) in the air, the PFA resin has a reduction in the melt flow index because of an increase in the molecular weight due to bonding of terminal groups. However, this description merely indicates a change in a very long period of time, that is, several thousands hours, at least, not less than 1,000 hours so that, at present, it is difficult to put this method into practical use.

In contrast, in the present invention, the PFA composite resin which has a —CH₂OH terminal group, which has not been subjected to a stabilizing process, is mixed with a specific inorganic filler as a composite material and has a sufficient fluidity that allows a melt molding process, is utilized so that, in a realistic processing time from not less than 10 hours to not more than 300 hours that is practically applicable, the physical properties of the PFA composite resin can be improved.

The helical blade molded member, obtained in the method of the present invention, has an increased molecular weight in the PFA composite resin, that is, not more than 10 g/10 min, represented by the MFR value. Because of the increase in the molecular weight, the molded member is allowed to have superior physical properties, in particular, superior anti-fatigue property and sliding property.

The PFA composite resin to be used for molding the helical blade of the present invention is preferably set to a range of 15 to 50 g/10 min represented by the MFR value. The resin having an MFR value of less than 15 g/10 min makes the melt viscosity too high, causing a difficulty in allowing the resin to flow along the long spiral shape of the helical blade to the end and the subsequent failure in providing high dimensional precision and surface smoothness. In contrast, the resin having an MFR value exceeding 50 g/10 min makes the viscosity too low, resulting in burrs and degradation in the heat resistance; thus, thermal deterioration tends to occur during the injection molding, making it difficult to produce the product in a stable manner.

In other words, the present invention features that, after a molding process has been carried out by using a PFA composite resin formed by a PFA resin with a comparatively low molecular weight, which has high fluidity and is easily molded, and an inorganic filler, the resulting molded matter is subjected to a heating treatment under specific conditions so that a helical blade having a superior anti-fatigue property and sliding property can be obtained.

The molded resin material to be used in the present invention is a PFA resin which has a —CH₂OH terminal group, which has not been subjected to a stabilizing process.

The number of —CH₂OH terminal groups is preferably set to not less than 40 to not more than 400 per 10⁶ carbon atoms. In particular, the number is more preferably set in a range of 100 to 400. The number of the groups of less than 40 fails to improve the molecular weight quickly, taking too much time to improve the molecular weight; in contrast, the number greater than 400 cause degradation in the thermal stability.

In order to improve the thermal stability and chemical stability, the PFA resin is normally stabilized with its molecular terminal being formed into —CF₃ or —CONH₂; however, the PFA resin to be used in the present invention has not been subjected to any stabilizing process in its terminal group. Here, the PFA resin, which has not been subjected to any stabilizing process in its terminal group, refers to those resins having structures, such as —CF═CF₂, —CH₂OH, —COF, —COOCH₃ and —COOH, in the terminal thereof.

The PFA composite resin to be used in the present invention is allowed to have an increased molecular weight through a heating treatment at a temperature of 280 to 300° C. for a period of time from not less than 10 hours to not more than 300 hours so that it becomes possible to improve the anti-fatigue property and sliding property in the helical blade molded member.

The above-mentioned molecular-weight increasing reaction of the PFA composite resin is a reaction inherent to the PFA itself, and is considered to be carried out in the following reaction mechanism:

˜CF═CF₂+O·→˜CF—COF

˜CF—COF+˜CH₂OH→˜CF(CCF)OCH₂˜

The other unstable terminal groups are changed into ˜CF═CF₂ through a heating process. This fact is proved by a reduction in the peak corresponding to —CH₂OH group (3650 cm⁻¹) in infrared-absorbing spectrum and an increase in the peak corresponding to—COF group (1883 cm⁻¹)

The PFA composite resin to be used in the present invention fails to sufficiently improve the molecular weight when the heating treatment time at a temperature in a range of 280 to 300° C. is less than 10 hours, and the treatment time longer than 300 hours minimizes the progress of the reaction, with the result that the longer treatment time merely causes poor production efficiency.

The heating treatment temperature lower than 280° C. fails to allow the molecular weight increasing reaction to sufficiently progress in a short time, and the temperature exceeding 300° C. is too close to the melting point, making it impossible to maintain the shape and dimensional precision of the helical blade molded member.

In the heating treatment of the prevent invention, since oxygen is related to the molecular weight increasing reaction, the treatment is preferably carried out in the air or in an oxygen gas.

With respect to the filler to be used to improve the wear and abrasion resistance of the helical blade, the applicable materials are generally classified into inorganic substances and organic substances. One of the prerequisites of the filler is high heat resistance which prevents thermal deterioration even under a high molding treatment temperature of the PFA resin.

Examples of the inorganic filler material include inorganic fibers and whiskers, such as glass fibers, carbon fibers, graphite fibers, wollastonite, potassium titanate whisker, carbon whisker, silicon carbide whisker and sapphire whisker, and particles of materials such as graphite, molybdenum disulfide, boron nitride, silicon carbide and other ceramics.

Examples of the organic filler material include fibers and particles formed by materials such as aromatic polyimide and total aromatic polyester.

However, the organic filler tends to cause an oxidizing reaction (suspicion of oxidation deterioration) due to the thermal treatment of the present invention, and consumes oxygen, with the result that the molecular weight increasing reaction of the PFA resin does not take place sufficiently.

For this reason, since it is impossible to obtain sufficient anti-fatigue property and sliding property of the helical blade, the inorganic filler that does not cause any change in characteristics such as oxidation due to the temperature of the heating treatment is preferably used.

The amount of the inorganic filler is preferably set in a range of 1 to 15 weight %. The amount of the filler of less than 1 weight % provides hardly any effects for improving the abrasion resistant property. The amount of the filler exceeding 15 weight % causes the fatigue characteristic of the PFA resin to extremely deteriorate, and also causes degradation in the fluidity and the subsequent degradation in the moldability.

Referring to the attached drawings, the following description will discuss the helical blade of the present invention.

FIG. 1 is a longitudinal cross-sectional view that shows a helical compressor to which the present invention is applied. This helical compressor 10 is installed in a refrigerating cycle device such as a refrigerator and an air conditioner. The helical compressor 10 is a compressor of a horizontal type in which a spiral-shaped blade, that is, a helical blade 25, is adopted, and the horizontal helical compressor 10 is provided with an electric motor 12 housed on one side of a sealing case 11 and a helical-blade-type compressor mechanism 13 that is driven by the electric motor 12.

The compressor mechanism 13 is provided with a sleeve-shaped cylinder 23 that is housed and secured in the sealing case 11, a roller 24 that is housed in this cylinder 23 in an eccentric manner and a spiral-shaped helical blade 25 that is interposed between the above-mentioned cylinder 23 and the roller 24. Outer circumferential flanges 23a, 23b are integrally formed on both of the sides of the above-mentioned cylinder 23, and a main bearing 20 and a sub-bearing 21 are secured to these outer circumferential flanges 23a, 23b through fastening means such as fastening screws.

The roller 24 of the helical-blade-type compressor mechanism 13 is attached to the shaft of a crank unit 18a of a crank shaft 18 so as to freely rotate thereon, and allowed to rotate eccentrically following the rotation movement of the crank shaft 18. An Oldham's mechanism 27 is placed between the roller 24 and the sub-bearing 21 so as to prevent the roller 24 from rotating. This Oldham's mechanism 27 prevents the rotation of the roller 24 so that the roller 24 is allowed to make revolving movements within the cylinder 22 without rotating.

A spiral-shaped groove 28 is formed in the outer circumferential face of the roller 24. This spiral-shaped groove 28 is formed so as to have uneven pitches, with the groove pitches being made smaller from the sub-bearing 21 side toward the main bearing 20 side. The helical blade 25 is fitted to the spiral-shaped groove 28 of the roller 24.

This helical blade 25 makes it possible to form a plurality of compressor chambers 30 between the cylinder 23 and the roller 24 along the axis direction.

The helical blade 25 is fitted to the spiral-shaped groove 28 of the roller 24 with its diameter being forcefully reduced, and assembled so that the outer circumferential face of the helical blade 25 is allowed to elastically contact the inner circumferential wall face of the cylinder 23 along the entire portion thereof. Thus, the inner circumferential wall face of the cylinder 23 is sealed by the helical blade 25.

The spiral pitches of the helical blade 25 are uneven pitches, which are formed to have the same pitches as the spiral-shaped groove 28 of the roller 24.

FIG. 2 shows one example of a helical blade of the present invention, which is molded through an injection molding process. FIG. 2(A) is a drawing that shows the side view of the entire helical blade, and FIG. 2(B) is a traverse cross section of the helical blade.

### BRIEF DESCRIPTION OF DRAWINGS

FIG. 1 is a vertical sectional view that shows one embodiment of a helical compressor in accordance with the present invention.

FIG. 2 is a drawing that shows a general shape of a helical blade of the present invention, FIG. 2(a) is a side view thereof, and FIG. 2(b) is a traverse cross-sectional view.

FIG. 3 is a cross-sectional view showing an injection molding metal mold that is used for molding the helical blade.

FIG. 4 is a characteristic diagram showing the relationship between the cross-sectional precision of the injection molded product and the number of helical turns upon molding the helical blade in which a PFA composite resin having a different MFR value is used.

FIG. 5 is a characteristic diagram showing the relationship between the change in the MFR value of the PFA composite resin and the heating time in the respective heating treatments of the helical blade injection molded product.

### BEST MODE FOR CARRYING OUT THE INVENTION

The following description will discuss the present invention in detail by means of examples.

### EXAMPLE 1

### Relationship Between MFR Value of a Material PFA Composite Resin and its Injection Moldability and Variations in MFR Value Caused by Heating Treatments.

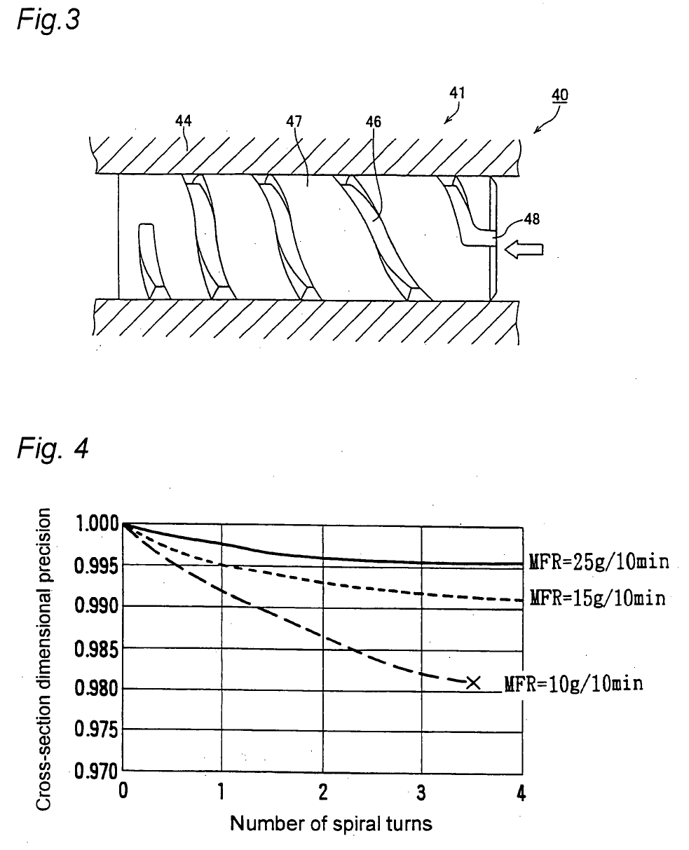

In order to review the relationship between the MFR value and the dimensional precision of the helical blade, injection-molding tests were carried out by using a metal core 47 shown in FIG. 3 with respect to PFA composite resins having different MRF values.

The number of —CH₂OH terminal groups was measured by using a press film of a PFA composite resin having a thickness of approximately 200 μm through infrared-absorbing spectrum measurements by the use of an FT-IR device. The quantitative analysis of the terminal groups was carried out based upon differential spectra between sample spectra and a standard sample that had been completely fluorinated. In order to calculate the number of —CH₂OH terminal groups per 10⁶ carbon atoms, a correction coefficient was determined from a model compound, and the height of the absorbing peak of the differential spectrum was multiplied by the correction coefficient so that the number of the target PFA terminal groups was calculated. The absorbing peaks and correction coefficients thus used are shown below:

TABLE 1

| Terminal group | Absorbing peak | Correction coefficient |
|---|---|---|
| —COF | 1883 cm⁻¹ | 390 |
| —CH₂OH | 3650 cm⁻¹ | 1800 |

More specifically, to glass fibers of 10% by weight (made by Nippon Electric Glass Co., Ltd.; EPG-70) were injected the following PFA resins having respective MFRs of 13 g/10 min, 18 g/10 min and 30 g/10 min, and kneaded under the following kneading conditions to give PFA composite resin pellets (molded resin elements) respectively having MFRs of 10 g/10 min, 15 g/10 min and 25 g/10 min.

### PFA Resins

13 g/10 min: [trade name “Aflon P63” made by Asahi Glass Co., Ltd.: Number of —CH₂OH terminal groups per 10⁶ carbon atoms=180]

18 g/10 min: [trade name “Aflon P63p” made by Asahi Glass Co., Ltd.: Number of —CH₂OH terminal groups per 10⁶ carbon atoms=200]

30 g/10 min: [trade name “Aflon P62X” made by Asahi Glass Co., Ltd.: Number of —CH₂OH terminal groups per 10⁶ carbon atoms=220]

### Kneading Conditions

Device: Biaxial extruder KTX-37 made by Kobe Steel, Ltd.

Kneading conditions: Cylinder temperature 360° C.,

Dies temperature 350° C.

### MFR Measurements

Device : Melt Indexer made by Toyo Seiki Seisaku-sho, Ltd.

Measuring conditions: 372° C., 5 kgf

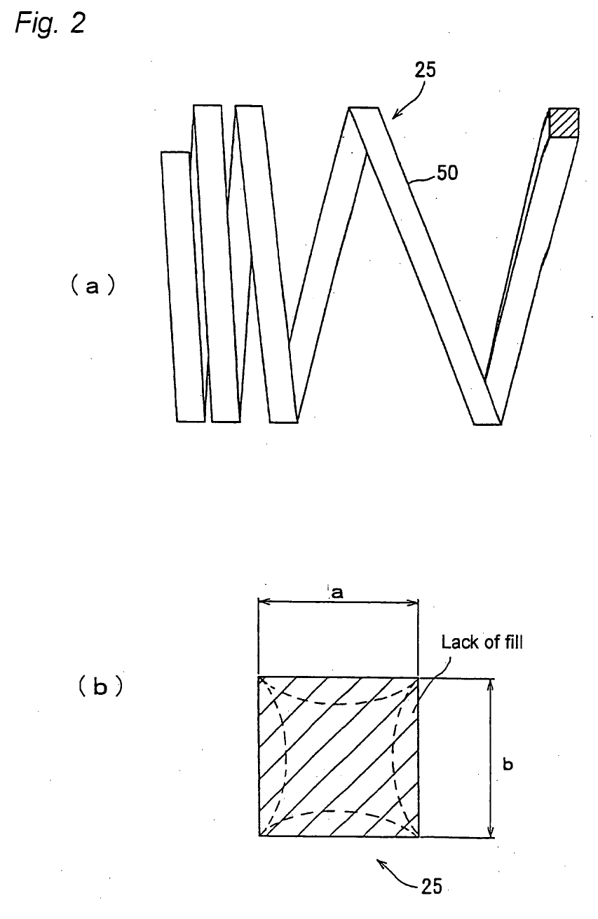

Spiral groove 46, formed in the metal mold core 47, had four turns from an injection gate 48, and the metal mold core 47 having a rectangular cross-section shown in FIG. 2(b) was prepared, and a helical blade 25 was molded through an injection molding device 40 under the following molding conditions.

FIG. 4 shows the relationship between the spiral fluidity length of the helical blade 25 obtained by the above-mentioned experiment and the cross-sectional precision shown in FIG. 2(b) for each of MFR values of the PFA composite resins.

### Molding Conditions

Injection molding machine: J100 EII-Type-P made by JSW Plastic Machinery Inc.

Molding temperature:Resin temperature 380° C., Metal mold temperature 220° C., Injection pressure 75 MPa

Moreover, in the above-mentioned injection molding experiment, the precision of the cross-section shown in FIG. 2(b) is found by measuring dimensions a′ and b′ of a molded member that correspond to the center portions of side a and side b respectively, and represented by a relative ratio calculated with respect to specified dimensions a and b, as shown below:

Cross-section dimensional precision=a′/a or b′/b. Deterioration in cross-sectional precision causes a concave shape referred to as “lack of fill”, with the result that the cross-sectional precision becomes smaller than 1.

As shown in FIG. 4, the PFA composite resins with MFR values of 5 g/10 min and 10 g/10 min failed to reach 4 turns as the specific number of spiral turns, and even at portions that the resin had reached, the cross-sectional precision was low. In other words, the fluidity in the PFA composite resins became insufficient, failing to provide a helical blade 25 having sufficient performances.

In contrast, the PFA composite resins with MFR values of 15 g/10 min and 25 g/10 min reached 4 turns with superior cross-sectional precision. In particular, the PFA composite resin material of MFR 25 g/10 min has superior cross-sectional precision, and it is confirmed that the higher the MFR value, the higher precision the helical blade 25 has.

The metal mold core 47, shown in FIG. 3, represents one example of a shape of a helical blade 25, and the application of a PFA composite resin having high fluidity with a great MFR value makes it possible to provide high dimensional precision, and also to achieve a smaller cross-section (which makes dimensional variations upon thermal expansion and swelling smaller, and provides a higher sealing property in a wider application range with a smaller clearance between the spiral-shaped groove 28 of the roller and the helical blade) and an increase in the number of turns (which makes a differential pressure smaller, thereby improving the reliability of the helical blade 25); thus, it becomes possible to obtain higher reliability and compressor driving efficiency.

### EXAMPLE 2

### Improvements of Molded-Member Performances by Heating Treatments

Next, in order to examine effects of a MFR value reduction (increased molecular weight) caused by heating treatments of a PFA composite resin, a helical blade 25 (with high dimensional precision), which was injection-molded by using a PFA composite resin having an MFR value of 25 g/10 min as described in FIG. 4, was used, and these were placed at hot air thermostats respectively set to temperatures of 250, 270, 280, 290, 300 and 305° C. (made by Tojo Netsugaku CO., LTD.), and subjected to heating processes up to 300 hours. The maximum setting time was determined as 300 hours by taking the productivity into consideration.

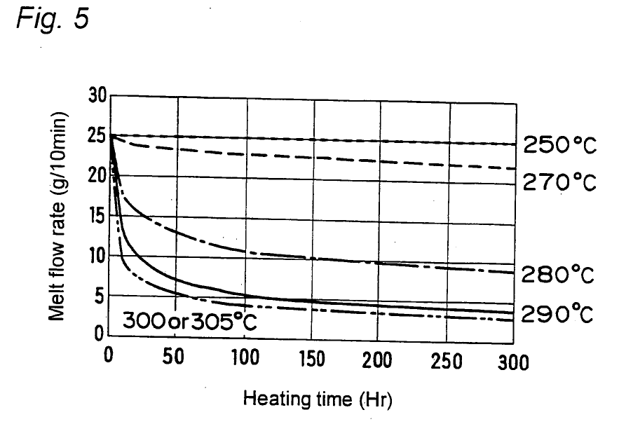

MFR values of the above-mentioned helical blades 25 were measured after the heating treatments, and the relationship between the MFR value and the heating time was shown in FIG. 5 for each of the heating temperatures.

In order to examine effects of the improvements in physical characteristics by the heating treatments of the above-mentioned PFA composite resins, flat-plate test pieces (12×12×2 mm) were injection-molded under the above-mentioned molding conditions, and simultaneously with the above-mentioned helical blades 25, these were placed at hot air thermostats respectively set to temperatures of 250, 270, 280, 290, 300 and 305° C. (made by Tojo Netsugaku CO., LTD.), and subjected to heating processes of 10 hours and 300 hours.

With respect to both of those test pieces that were simply injection-molded and those test pieces that were subjected to the above-mentioned heating treatments, physical characteristics, such as an anti-repeated bending fatigue characteristic (flex life characteristic) and a sliding characteristic in an oil lubricating state, were examined, and with respect to comparative examples, test pieces, obtained by simply injection-molding the PFA resin (MFR 30 g/10 min; “Aflon P62X” made by Asahi Glass Co., Ltd.) that was a material of the above-mentioned PFA composite resins, were subjected to the same tests.

### Physical Characteristics and Evaluation Method of Resin Characteristics

### (1) Repeated Bending Fatigue Characteristic (Flex Life Characteristic)

Repeated bending tests were carried out by using a repeated bending tester so that the service life of the test piece was evaluated based upon the number of repetition cycles until a crack occurred in the test piece.

Test piece width: 3 mm

Grip length of test piece: 3 mm

Bending angle: 15°

Repeated cycles: 600 cpm (cycles/min)

### (2) Sliding Characteristic (Amount of Abrasion, Coefficient of Dynamic Friction)

Measurements were carried out in compliance with JIS K-7218 method in the following manner.

The flat-shape test piece was made in contact with a cylinder-shaped opposing metal member, and one of these was rotated under a fixed load so that the amount of abrasion was measured based upon the reduction in weight of the test piece. With respect to the coefficient of dynamic friction, a torque meter was attached to the side supporting the test piece that was not rotated, and the value is obtained by dividing the rotation force calculated from the rotation torque during the tests by the load.

Opposing metal member: S45 C (hardness: HRC18, surface roughness: 0.8 μmRa)

Load: 16 kg/cm²

Rotation speed: 0.75 m/sec

Testing time: 24 hours

Lubricating oil: SUNISO 4GSD (refrigerator oil made by Japan Sun Oil Company Ltd.)

### (3) MFR

Measurements were carried out in compliance with JIS K-7210 B method.

Table 2 shows changes in MFR value when the heating treatment temperature and heating treatment time are changed, Table 3 shows the number of repeated bending fatigue cycles, Table 4 shows the amount of abrasion and Table 5 shows the coefficient of dynamic friction, respectively in with those prior to the heating treatment and those of the base PFA resin.

When the test piece that had been subjected to the heating treatment of example 2 was heated to 320° C. higher than the melting point, the test piece was fused so that it was confirmed that it had no cross-linking structure.

TABLE 2

| | | |
|---|---|---|
| | | MFR after heating treatment |
| Original MFR | Heating treatment | (g/10 min) |

| (g/10 min) | temperature (° C.) | 10 hours | 300 hours |
|---|---|---|---|
| 25 | 250 | 25 | 25 |
| | 270 | 24 | 22 |
| | 280 | 18 | 9 |
| | 290 | 14 | 4 |
| | 300 | 10 | 3 |
| | 305 | 9 | 3 |

TABLE 3

| | | |
|---|---|---|
| | | Bending life (times) |
| Original bending | Heating treatment | after heating treatment |

| life (times) | temperature (° C.) | 10 hours | 300 hours |
|---|---|---|---|
| PFA composite | 250 | 3 × 10⁴ | 3 × 10⁴ |
| material 3 × 10⁴ | 270 | 3 × 10⁴ | 4 × 10⁴ |
| | 280 | 7 × 10⁴ | 5 × 10⁵ |
| PFA resin | 290 | 1 × 10⁵ | 2 × 10⁶ |
| material 2 × 10⁵ | 300 | 5 × 10⁵ | 3 × 10⁶ |
| | 305 | 6 × 10⁵ | 3 × 10⁶ |

TABLE 4

| | | |
|---|---|---|
| Original | Heating | Reduced amount in |
| reduced amount | treatment | abrasion after heating |
| in abrasion | temperature | treatment (mg) |

| (mg) | (° C.) | 10 hours | 300 hours |
|---|---|---|---|
| PFA composite | 250 | 5.2 | 4.9 |
| material 4.8 | 270 | 4.7 | 4.4 |
| | 280 | 3.8 | 2.6 |
| PFA resin | 290 | 3.4 | 1.3 |
| material 38.0 | 300 | 2.8 | 0.9 |
| | 305 | 2.9 | 1.0 |

| | | |
|---|---|---|
| | | Coefficient of dynamic |
| Original | Heating | friction after heating |
| coefficient of | treatment | treatment |

| dynamic friction | temperature (° C.) | 10 hours | 300 hours |
|---|---|---|---|
| PFA composite | 250 | 0.052 | 0.051 |
| material 0.048 | 270 | 0.047 | 0.046 |
| | 280 | 0.042 | 0.031 |
| PFA resin | 290 | 0.037 | 0.028 |
| material 0.021 | 300 | 0.034 | 0.025 |
| | 305 | 0.034 | 0.024 |

In accordance with the results shown above, the MFR value drops at a heating treatment temperature in a range of 280 to 305° C., thereby improving the physical characteristics; however, at 305° C. the helical blade 25 is thermally deformed, failing to retain its shape. Moreover, during the heating treatment time from 10 to 300 hours, changes in the MFR value and the physical characteristics occur remarkably.

More specifically, by compounding the PFA resin, the bending fatigue characteristic and the characteristic of the coefficient of dynamic friction deteriorate, although the frictional characteristic is improved. However, these characteristics are improved by the heating treatment at a treatment temperature of 280 to 300° C. for a treatment period of time of 10 to 300 hours so that the characteristics required for the helical blade 25 are satisfied.

In particular, in the case of an MFR value of not more than 10 g/10 min after the heating treatment, it is possible to improve these physical characteristics effectively.

### EXAMPLE 3

### MFR Change in a Molded Member with Respect to Kinds of Fillers for PFA Composite Resin and Heating Treatments

By using the PFA resin of 30 g/10 min, “Aflon P62X” (trade name, made by Asahi Glass Co., Ltd.; number of —CH₂OH terminal groups per 10⁶ carbon atoms: 220) in example 1, experiments were carried out with respect to the kinds of fillers and the effects of heating treatments.

More specifically, a filler that has proper heat resistance, and is less susceptible to thermal decomposition under the PFA resin molding temperature was selected, and with respect to the inorganic substance, glass fiber (EPG-70; made by Nippon Electric Glass Co., Ltd.), carbon fiber (MM207; made by Petoca Materials Ltd.) and graphite (J-ACP; made by Nippon Graphite Industries Co.,Ltd.) were selected, with polyimide resin (PAW-20; made by MIKASA INDUSTRY CO.,LTD) being selected as the organic substance. These materials were filled in the above-mentioned PFA resin under the kneading conditions of example 1. In order to properly compare MFR values, the filler amount was properly determined by taking the specific gravity and shape of the filler into consideration so that the MFR values were adjusted to 15 g/10 min and 25 g/10 min.

Test pieces were injection-molded in the same manner as example 2 by using the above-mentioned PFA composite resin, and after these had been subjected to heating treatments at 280° C. for 300 hours, the MFR values were measured. Table 6 shows the results of the tests.

TABLE 6

| | MFR after heating treatment at 280° C. for 300 | | | |
|---|---|---|---|---|
| Original MFR | hours (g/10 min) | | | |
| (g/10 min) | Glass fiber | Carbon fiber | Graphite | Polyimide |
| 15 | 5 | 6 | 7 | 13 |
| 25 | 8 | 8 | 9 | 19 |

The above-mentioned results show that the PFA resin filled with thermally stable glass fiber, carbon fiber or graphite showed a reduction in the MFR value by the heating treatment. However, in the case of the polyimide resin, the reduction in the MFR value is small, thereby indicating that the filler inhibited the reaction of the PFA resin.

In other words, it is needless to say that the inorganic filler is suitable for use as a filler for improving various characteristics of the helical blade 25.

### EXAMPLE 4

### MFR Change in Molded Member with Respect to Number of Terminal Groups of PFA Resin and Heating Treatments

In order to examine changes in MFR value due to the number of —CH₂OH terminal groups and heating treatments, by compounding the same glass fiber as example 1 in the following base PFA resin, the PFA composite resin having an MFR value of 25 g/10 min was formed.

### PFA Resin

MFR 30 g/10 min (“Aflon P62X” trade name, made by Asahi Glass Co., Ltd.)

(1) Number of —CH₂OH terminal groups per 10⁶ carbon atoms: 52

(2) Number of —CH₂OH terminal groups per 10⁶ carbon atoms: 220

(3) Number of —CH₂OH terminal groups per 10⁶ carbon atoms: 380

(4) For comparative purpose, Teflon “Teflon 420 HP”, made by Du Pont-Mitsui Fluorochemicals Company Ltd., whose terminal groups were subjected to stabilizing treatments, was also used:

MFR 30 g/10 min (“Teflon 420 HP”)

Number of —CH₂OH terminal groups per 10⁶ carbon atoms: 0

Helical blades 25 were injection-molded in the same manner as example 2 by using the above-mentioned PFA composite resins, and after these had been subjected to heating treatments at 280° C. for 300 hours, the MFR values were measured. Table 7 shows the results of the tests.

TABLE 7

| | MFR after heating treatment at 280° C. for 300 | | | |
|---|---|---|---|---|
| | hours (g/10 min) | | | |
| Original | Number of | Number of | Number of | Number of |
| MFR | terminal | terminal | terminal | terminal |
| (g/10 min) | groups 52 | groups 220 | groups 380 | groups 0 |
| 25 | 12 | 8 | 6 | 25 |

The above-mentioned results show that, when the PFA resin whose —CH₂OH terminal groups are subjected to stabilizing treatments is used, it is not possible to obtain effects of heating treatments. Moreover, with respect to the effects given by the heating treatments, the tendency is that the greater the number of —CH₂OH terminal groups, the more easily the effects are obtained; however, since the thermal stability of the material is lowered, thermal deterioration tends to occur upon application of heat in the injection-molding process, resulting in a problem of unstable precision.

Therefore, it is preferable to use PFT resins having —CH₂OH terminal groups of not less than 40 to not more than 400 per 10⁶ carbon atoms.

### EXAMPLE 5

### Change in Performances of a Helical Compressor Using a Helical Blade of a PFA Composite Resin by Heating Treatments

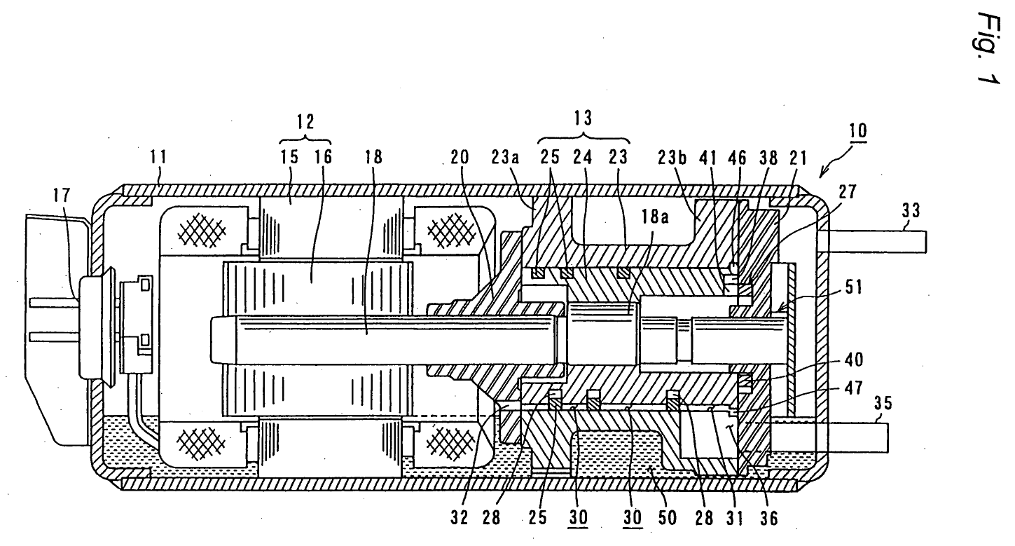

Helical blades 25 that were different in dimensional precision, which had been injection-molded by using PFA composite resins having MFR values of 15 g/10 min and 25 g/10 min in example 2, were subjected to heating treatments at 290° C. for 300 hours. The resulting blades were installed in a helical compressor shown in FIG. 1 so that compressor performances were measured. For comparative purpose, the same helical blade 25 that had not been subjected to heating treatments was also used.

More specifically, “Freon 134a” was used as the refrigerant gas and the test pieces were subjected to a rotation speed of 50 rps. Then, the load power and refrigerating capability after the driving process of 50 hours were measured to find a driving efficiency (refrigerating capability/load power), and the results shown in Table 8 were obtained.

Table 8 shows the load power, refrigerating capability and driving efficiency as relative ratios calculated by defining the example that was made by a PFA composite resin having an MFR value of 15 g/10 min and subjected to a heating process as 100.

TABLE 8

| MFR of | Presence or | Load | Refrigerating | Relative |
|---|---|---|---|---|
| blade | absence of | power- | capability- | driving |
| (g/10 | heating | Relative | Relative | efficiency |
| min) | process | exponent | exponent | (%) |
| 15 | Yes | 100 | 100 | 100 |
| 25 | Yes | 95 | 106 | 112 |
| 15 | No | 108 | 100 | 93 |
| 25 | No | 106 | 106 | 100 |

Table 8 shows that the heating process makes it possible to reduce the coefficient of dynamic friction between the helical blade 25 and the roller groove 24, to minimize the load power, and consequently to provide a high driving efficiency. Since the application of a PFA composite resin having a high MFR value provide high dimensional precision, it becomes possible to improve the sealing property of the refrigerant gas, to enhance the refrigerating capability, and also to provide the same. effects.

The application of the PFA composite resin provides superior abrasion resistance, and the heating process improves the declining anti-fatigue property, thereby making it possible to greatly improve the reliability.

The embodiment of the present invention has explained an example in which a helical blade is fitted and inserted to a spiral-shaped groove on a roller; however, a spiral-shaped groove may be formed in the inner circumferential wall of a cylinder, and the helical blade may be fitted and inserted to the spiral-shaped groove formed in the cylinder. In this case, the inner circumferential wall of the helical blade is always kept in contact with the outer circumferential face of the roller.

With respect to a device of a type in which a compressor mechanism unit is fitted and inserted to the inside of a motor unit with the cylinder, roller and blade being allowed to rotate, it is needless to say that since the relative movements of the respective parts and functions required by the helical blade are the same, this invention is also applicable.

### Industrial Applicability

In the blade structure of a helical compressor and the blade manufacturing method in accordance with the present invention, a PFA composite resin, which is formed by compounding an inorganic filler in a tetrafluoroethylene/perfluoroalkylvinyl ether copolymer (PFA resin) having a —CH₂OH terminal group, which has not been subjected to a stabilizing process, is molded into a helical blade through an injection-molding process, and the resulting matter is then subjected to a heating process at a temperature from 280 to 300° C. for a period from not less than 10 hours to not more than 300 hours so that the molecular weight of the PFA resin is increased in a short time; thus, it becomes possible to provide a helical blade having high productivity with its blade dimensional precision being improved, and consequently to improve the reliability of the helical blade as well as improving the compressor performances.

1. A manufacturing method of a compressor-use helical blade comprising the steps of:
preparing a PFA composite resin formed by mixing an inorganic filler with a tetrafluoroethylene/perfluoroalkylvinyl ether copolymer (PFA resin) having a —CH₂OH terminal group, which is subjected to a stabilizing process, and
after the resin is molded into a helical blade through an injection-molding process, subjecting the resulting matter to a heating process at a temperature from 280 to 300° C. for a period from not less than 10 hours to not more than 300 hours.

2. The manufacturing method of a compressor-use helical blade according to claim 1, wherein said PFA composite resin prior to the heating process has a fluidity value of not less than 15 g/10 min represented as an MFR (melt flow rate) value.

3. A compressor-use helical blade which is made from a PFA resin, and has a molecular weight increased by the method of claim 1 or claim 2.

4. The compressor-use helical blade according to claim 3, wherein the increased molecular weight has a value of not more than 10 g/10 min represented as an MFR value.

5. A compressor comprising:
a cylinder;
a roller that is placed in the cylinder in an eccentric manner; and
a helical blade that is placed in a spiral-shaped groove formed in either of said cylinder and roller with a pitch thereof being gradually reduced from one end toward the other end thereof, so as to freely stick out therefrom and retreat therein;
wherein said helical blade is formed by the steps of:
preparing a PFA composite resin formed by mixing an inorganic filler with a tetrafluoroethylene/perfluoroalkylvinyl ether copolymer (PFA resin) having a —CH₂OH terminal group, which is subjected to a stabilizing process; and
after the resin is molded into a helical blade through an injection-molding process, subjecting the resulting matter to a heating process at a temperature from 280 to 300° C. for a period from not less than 10 hours to not more than 300 hours.
